(19) United States
(12) Patent Application Publication
(10) Pub. No.: US 2024/0088753 A1
(43) Pub. Date: Mar. 14, 2024

(54) DEVICE FOR COOLING SEGMENTED ELECTRICAL CONDUCTORS

(71) Applicant: NIDEC PSA EMOTORS, CARRIERES SOUS POISSY (FR)

(72) Inventors: Romaric LENOIR, LE PORT MARLY (FR); Vincent BONNET, RUEIL MALMAISON (FR)

(21) Appl. No.: 17/773,298

(22) PCT Filed: Oct. 14, 2020
(86) PCT No.: PCT/FR2020/051814

§ 371 Date: Apr. 29, 2022

(30) Foreign Application Priority Data
Oct. 31, 2019 (FR) 1912299

(51) Int. Cl. H02K 9/197; H02K 3/24; H02K 3/28

(52) U.S. Cl. CPC H02K 9/197; H02K 3/24; H02K 3/28

(57) ABSTRACT

The invention relates to a cooling device (3) for cooling one or more electrical conductors (22) of a stator (2) of a rotating electrical machine (1), said device (3) comprising at least one cooling circuit (31) for a coolant (32), intended to be disposed in thermal contact with at least part of the electrical conductor(s) (22) during a step involving the welding of said electrical conductors.

### CROSS-REFERENCE TO RELATED APPLICATIONS

This application is the US National Stage under 35 USC § 371 of International App. No. PCT/FR2020/051814 filed Oct. 14, 2020 which in turn claims the priority of French application 1912299 filed on Oct. 31, 2019, the content of (text, drawings and claims) both said applications being incorporated here by reference.

### BACKGROUND

The present invention relates to a device for cooling one or more electrical conductors to be welded to a stator of a rotating electrical machine.

### TECHNICAL FIELD

The invention relates more particularly to synchronous or asynchronous alternating current machines. It relates in particular to traction or propulsion machines for electric motor vehicles (Battery Electric Vehicle) and/or hybrid motor vehicles (Hybrid Electric Vehicle-Plug-in Hybrid Electric Vehicle), such as individual cars, vans, trucks or buses. The invention also applies to rotating electrical machines for industrial and/or energy production applications, in particular naval, wind or aeronautical power applications.

### PRIOR ART

Welding several adjacent electrical conductors in a so-called raised edge configuration, that is to say, with electrical conductors that are at the same height, leads to welds that are difficult to penetrate. In addition, as the number of strands per electrical conductor increases, the more the welding energy necessary to carry out the welding of the electrical conductors increases.

When the energy required for welding is very high, in order to increase the penetration of the weld, there is a risk of destruction of the electrical conductors by accumulation of energy in the end to be welded, then melting and collapse of the welded end.

This high energy input can also lead to a pronounced degradation of the insulation and of the wires, and potentially of the insulation of the notches of the stator, which can lead to functional failures.

This can also result in the need for an increase in the height of the strands of the electrical conductors before welding, which leads to a large lead-out wire height.

There is a need to simply weld electrical conductors together without running the risk of damaging them during the welding operation.

The invention aims to allow easy welding of electrical conductors by discharging and channeling the excess energy through a cooling device.

### SUMMARY

### Cooling Device

According to one of its aspects, a device is disclosed for cooling one or more electrical conductors of a stator of a rotating electrical machine, the device comprising at least one cooling circuit for a coolant, intended to be placed in thermal contact with at least a part of the electrical conductor(s) during a step of welding said electrical conductors.

Electrical conductors are in “thermal contact” if they are close enough for a heat exchange to take place with the coolant.

Such a device allows efficient discharging of the heat transmitted to the electrical conductors to carry out the welding. It is thus possible to produce welds involving electrical conductors with a higher cross-section than those carried out traditionally. This cooling device also allows welding of electrical conductors comprising a greater number of strands.

The device allows the flow of molten material resulting from the weld to be limited. The geometry of the weld can thus be better controlled.

The cooling device also allows the electrical conductors to be properly held in place during the welding step.

At least some electrical conductors, if not a majority of the electrical conductors, can be in the form of U or I pins.

At least 30% of the electrical conductors may be in thermal contact with the cooling device. At least 50% of the electrical conductors may be in thermal contact with the cooling device. In one embodiment, all the electrical conductors of the stator are in thermal contact with the cooling device.

The cooling device may be of substantially flattened shape. It may comprise an upper face and a lower face. The lower face is for example intended to be opposite the stator during the welding step.

Preferably, the cooling device may have a contour with a shape similar to that of a cross-section of the stator. For example, the cooling device has a circular shape.

Advantageously, the cooling circuit can be configured to provide spaces for receiving the free ends of the electrical conductors to be welded.

In one embodiment, the spaces provided by the cooling circuit which receive for receiving the free ends of the electrical conductors to be welded and which are provided by the cooling circuit are located above the notches of the stator of the electrical machine.

The spaces for receiving the free ends of the electrical conductors to be welded may be of substantially rectangular shape, and in particular rectangular shape. As a variant, the device may comprise a single receiving space having the shape of a ring. This ring-shaped receiving space can extend along the entire circumference of the device.

The cooling circuit can be arranged above the teeth, between the notches of the stator. Thus, the electrical conductors that are arranged in the notches can be easily inserted into the cooling device.

In a variant embodiment, the cooling device provides as many receiving spaces for the free ends of the electrical conductors to be welded as there are notches in the stator.

As a variant, the cooling device provides fewer receiving spaces for the free ends of the electrical conductors to be welded than there are notches in the stator. In this case, the free ends of the electrical conductors present in different notches can be inserted into the same receiving space for the free ends of the electrical conductors to be welded. For example, if the cooling device has half as many receiving spaces for the free ends of the electrical conductors to be welded as notches in the stator, then the free ends of the electrical conductors arranged in two adjacent notches can be inserted into the same space.

In one embodiment, the cooling device provides a single receiving space for the free ends of the electrical conductors of all the notches of the stator. In this embodiment, the electrical conductors arranged in the notches of the stator are all inserted into the single space created by the cooling device.

The underside of the cooling device may have a beveled shape at the receiving spaces for the free ends of the electrical conductors to be welded.

These insertion bevels make it easier to put the device in place on the stator of the electrical machine on which the welding step is carried out. In particular, these bevels facilitate the insertion of electrical conductors into the device.

The cooling circuit can be configured for a coolant to circulate through the cooling circuit circumferentially and/or radially with respect to the axis of rotation of the rotating electrical machine.

The coolant may for example contain water, oil, air, or glycol, this list not being exhaustive. The cooling circuit of the cooling device may comprise several coolant inlet points.

The cooling device can be configured to provide cross-circulation of the coolant in the cooling circuit. For example, the cooling circuit has two inlet points. Alternatively, the cooling circuit has more than two inlet points.

In one embodiment, the coolant circulates radially from the inside to the outside above all or part of the teeth of the stator. Alternatively, the coolant circulates radially from the outside to the inside above all or part of the teeth of the stator. In another embodiment, the coolant circulates radially from the inside toward the outside above a first tooth of the stator, then radially from the outside toward the inside above a second tooth, for example adjacent to the first tooth.

Advantageously, at least one of the radial sides and/or one of the circumferential sides of the electrical conductors arranged in the same notch of the stator is in thermal contact with the cooling circuit.

The term “radial side” means a side of an electrical conductor that extends in the radial direction of the machine. The term “circumferential side” means a side of an electrical conductor that extends in the circumferential direction about the axis of rotation of the machine.

In one embodiment, all radial sides and all circumferential sides of each of the stator electrical conductors are in thermal contact with the device.

Alternatively, all of the radial sides of each of the electrical conductors of the stator are in thermal contact with the cooling device and none of the circumferential sides of each of the electrical conductors are in thermal contact with the cooling device.

Alternatively, all of the circumferential sides and only one radial side of each of the electrical conductors are in thermal contact with the cooling device.

As a further variant, only one radial side of each of the electrical conductors is in thermal contact with the cooling device.

In another variant, only one radial side and one circumferential side of each of the electrical conductors are in thermal contact with the cooling device.

In another embodiment, certain electrical conductors are in thermal contact with the cooling device by their circumferential side only and the rest of the electrical conductors are in thermal contact by a radial side and a circumferential side.

The cooling circuit may comprise a conduit for the circulation of the coolant. The conduit may meander between the free ends of the electrical conductors to be welded.

“Meandering” means developing by forming corrugations. In a preferred embodiment, the cooling circuit meanders evenly, for example between all the electrical conductors. Thus, each corrugation surrounds electrical conductors arranged in the same notch of the stator.

Alternatively, the cooling circuit can wind or meander around electrical conductors arranged in different notches. For example, each corrugation surrounds electrical conductors arranged in two adjacent notches. For example, each corrugation surrounds the electrical conductors arranged in three adjacent notches.

Alternatively, the cooling circuit meanders irregularly between the electrical conductors.

The cooling circuit may comprise two concentric portions arranged radially on either side of the electrical conductors of the stator. The two portions can communicate via radial channels arranged between the electrical conductors, above all or part of the teeth of the stator.

A first cooling circuit portion is arranged inside the stator, in the space defined by the electrical conductors. A second cooling circuit portion is arranged outside the stator, outside the space defined by the electrical conductors. There may be one or more coolant inlet points for each portion of the cooling circuit. The inlet point(s) can be connected to the portion of the cooling circuit arranged outside. The coolant then flows from the outside to the inside.

As a variant, the inlet point(s) can be connected to the portion of the cooling circuit arranged inside. The coolant then flows from the inside to the outside.

As a further variant, there may be one or more inlet points situated on the two portions of the cooling circuit.

The cooling circuit may comprise two concentric portions arranged radially on either side of the electrical conductors of the stator that do not communicate with each other. The coolant can circulate in each of said portions in opposite directions.

The two concentric portions of the cooling circuit can be passed through by counter-rotating coolants. As a variant, the two concentric portions of the cooling circuit can be passed through by coolants circulating in the same direction, for example in a counterclockwise direction about the axis of rotation of the electrical machine. Alternatively, the two concentric portions of the cooling circuit are passed through by coolants circulating in a counterclockwise direction about the axis of rotation of the electrical machine.

A first cooling circuit portion is arranged inside the stator, in the space defined by the electrical conductors. A second cooling circuit portion is arranged outside the stator, outside the space delimited by the sets of electrical conductors.

In one embodiment, the outer portion can be passed through by a coolant circulating in the counterclockwise direction and the inner portion can be passed through by a coolant circulating in the counterclockwise direction.

Alternatively, the outer portion can be passed through by a coolant circulating in the counterclockwise direction and the inner portion can be passed through by a coolant circulating in the counterclockwise direction.

The device can be at least partially manufactured by additive manufacturing, for example using a 3D printer.

Such a manufacturing method allows the manufacture of a cooling device specifically adapted to the stator on which the welding operation is carried out.

Assembly

An assembly is disclosed comprising a cooling device as defined above and a stator of a rotating electrical machine, the stator comprising a stator mass comprising notches provided between teeth, each notch receiving one or more electrical conductors.

The stator may comprise at least some electrical conductors, if not a majority of the electrical conductors, in the form of U or I pins.

The cooling device is positioned above the stator at a non-zero distance d during welding of the electrical conductors of the stator.

Winding

The electrical conductors can form a single winding, in particular whole or fractional. “Single winding” means that the electrical conductors are electrically connected together in the stator, and that the connections between the phases are made in the stator, and not outside the stator, for example in a terminal box.

The electrical conductors can form a distributed winding. The winding is not concentrated or wound on a tooth.

The winding is whole or fractional. The winding can be whole in pitch with or without shortening, or, in a variant, fractional. In one embodiment, the electrical conductors form a fractional winding, in particular with a shortened pitch. The number of notches in the stator can be between 18 and 96, better still between 30 and 84, being for example 18, 24, 27, 30, 36, 42, 45, 48, 54, 60, 63, 72, 78, 81, 92, 96 or even more preferably being 60 or 63. The number of poles of the stator can be between 2 and 24, or even between 4 and 12, for example 6 or 8.

The winding may comprise a single winding path or several winding paths. The current of the same phase flows by winding path in an “electrical conductor.” “Winding path” means all the electrical conductors of the machine that are traversed by the same electric current of the same phase. These electrical conductors can be connected to each other in series or in parallel or in series-parallel. In the case where there is only one channel, the electrical conductors are connected in series. In the case where there are several channels, the electrical conductors of each channel are connected in series, and the channels are connected in parallel.

### Electrical Conductors

The current of the same phase of a winding path flows in an “electrical conductor.” Several electrical conductors in series form a “coil.” The number of coils per phase is at most equal to the number of poles of the stator or to the number of pairs of poles.

In each notch there can be one or more layers. “Layer” refers to the electrical conductors in series belonging to the same phase arranged in the same notch. In each layer of a notch, there are electrical conductors of the same phase. In general, the electrical conductors of a stator can be distributed in one layer or in two layers. When the electrical conductors are distributed in a single layer, each notch only houses electrical conductors of the same phase.

The electrical conductors can be divided into only two layers. In this case, one or more notches can house electrical conductors of two different phases. This is always the case for a winding with shortened pitch. In one embodiment, the winding may not comprise more than two layers. In one embodiment, it notably does not have four layers.

At least a first electrical conductor housed in a first notch can be electrically connected to a second electrical conductor housed in a second notch, at the outlet from said notches.

“Electrically connected” means any type of electrical connection, in particular by welding, with different possible welding methods, in particular laser, TIG, induction, friction, ultrasound, vibrations or brazing, or by mechanical clamping, in particular by crimping, screwing or riveting for example.

The first and second notches are preferably non-consecutive.

The first and second electrical conductors can be electrically connected to the outlet of the first and second notches, that is to say that the electrical connection is formed on the electrical conductors just after their exit from the two notches, at an axial end of the stator mass. The electrical connection can be made in a plane perpendicular to the axis of rotation of the machine. The plane of the electrical connection can be less than 60 mm away from the stator mass, better still less than 40 mm away, for example 27 mm or 38 mm approximately.

A majority of the electrical conductors housed in a first notch can each be electrically connected to a respective second electrical conductor housed in a second notch, at the outlet of said notches. At least one notch, better still a majority of the notches, or even more than half of the notches, better still more than two-thirds of the notches, or even all of the notches, may comprise first electrical conductors each electrically connected to a respective second electrical conductor housed in a second notch, at the outlet of said notches.

In one embodiment, all the electrical conductors having a free end located at the same circumferential position about the axis of rotation of the machine, regardless of their radial position, are electrically connected together.

The first and second electrical conductors can each comprise an oblique portion. The oblique portions may extend in a circumferential direction about the axis of rotation of the machine. The two oblique portions can be configured to converge toward one another and thus allow the electrical connection to be made.

An electrical conductor can comprise two oblique portions, one at each of its two ends. The two oblique portions of the same electrical conductor can extend in opposite directions. They can diverge from each other. They can be symmetrical with respect to each other.

A majority of the electrical conductors can comprise one or more oblique portions as described above.

The electrical conductors can be arranged in the notches in a distributed manner. “Distributed” means that the outgoing and return electrical conductors are each housed in different and non-consecutive notches. At least one of the electrical conductors can pass successively through two non-consecutive notches.

The electrical conductors can be arranged in a row in the notches. “Row” means that the electrical conductors are not arranged in the notches in bulk, but in an orderly manner. They are stacked in the notches in a non-random manner, for example arranged in a row of electrical conductors aligned in the radial direction. Alternatively, they are arranged in a row of electrical conductors aligned in the circumferential direction about the axis of rotation of the machine. In one embodiment, the strands of one or more electrical conductors are arranged in a row of strands of electrical conductors aligned in the radial direction. Alternatively, they are arranged in a row of strands of electrical conductors aligned in the circumferential direction about the axis of rotation of the machine.

The electrical conductors may have a generally rectangular cross-section, in particular with rounded edges. The circumferential dimension of an electrical conductor can correspond substantially to the width of a notch. Thus, a notch may comprise only a single electrical conductor in its width. The width of the notch is measured in its circumferential dimension about the axis of rotation of the machine.

The electrical conductors can be adjacent to each other by their long sides, otherwise called the flat.

Optimizing the stack can make it possible to place a greater quantity of electrical conductors in the notches, and therefore to obtain a stator of greater power at a constant volume.

Each notch can comprise from 2 to 36 electrical conductors, in particular from 2 to 24, better still from 2 to 12 electrical conductors. Each notch may comprise from two to eight electrical conductors, in particular from two to four electrical conductors, for example two or four electrical conductors. In a variant embodiment, each notch comprises two electrical conductors. In another variant embodiment, each notch comprises four electrical conductors.

### Pins

At least some electrical conductors, if not a majority of the electrical conductors, can be in the form of U or I pins. The pin can be U-shaped (a “U-pin”) or straight, being I-shaped (an “I-pin”).

The pin and flat electrical conductors increase the filling coefficient of the notch, making the machine more compact. Due to a high filling coefficient, the thermal exchanges between the electrical conductors and the stator mass are improved, which makes it possible to reduce the temperature of the electrical conductors inside the notches.

Furthermore, the manufacture of the stator can be facilitated by the electrical conductors in pin form. In addition, the winding with pins can be modified easily by changing only the connections between the pins at the coil heads. Finally, since the pins do not need to have open notches, it is possible to have closed notches that make it possible to hold the pins, and it is therefore possible to eliminate the step of inserting stator shims.

Electrical conductors, indeed a majority of electrical conductors, extend axially in the notches. The electrical conductors can be introduced into the corresponding notches by one or both axial ends of the machine.

An I-shaped electrical conductor has two axial ends each placed at one of the axial ends of the stator. It passes through a single notch, and can be welded at each of its axial ends to two other electrical conductors, at the axial ends of the stator. The stator may for example comprise six or twelve electrical conductors in the shape of an I, the other electrical conductors possibly all being in the shape of a U.

A U-shaped electrical conductor has two axial ends both placed at one of the axial ends of the stator. It passes through two different notches, and can be welded at each of its axial ends to two other electrical conductors, at the same axial side of the stator. The bottom of the U is placed on the other axial side of the stator.

Strands

Each electrical conductor comprises one or more strands or wires). “Strand” refers to the most basic unit for electrical conduction. A strand can be of round cross-section, which may then be called “wire,” or may be flat. The flat strands can be shaped into pins, for example U or I pins. Each strand is coated with an insulating enamel.

The fact that each notch can comprise several electrical conductors and/or several strands makes it possible to minimize losses by induced currents, or AC Joule losses, which vary with the square of the supply frequency, which is particularly advantageous at high frequency and when the operating speed is high. It is thus possible to obtain better efficiency at high speed.

The presence of closed notches can make it possible to obtain a reduction in the leakage fluxes seen by the electrical conductors, which leads to a reduction in eddy current losses in the strands.

In one embodiment, each electrical conductor may comprise several pins, each forming a strand, as explained above. All the strands of the same electrical conductor can be electrically connected to each other at the outlet of the notch. The strands electrically connected to each other are placed in short circuit. The number of strands electrically connected together may be greater than or equal to 2, being for example between 2 and 12, being for example 3, 4, 6 or 8 strands.

Several strands can form the same electrical conductor. The same electric current of the same phase flows in all the strands of the same electrical conductor. All the strands of the same electrical conductor can be electrically connected to each other, in particular at the outlet of the notch. All the strands of the same electrical conductor can be electrically connected to each other at each of their two axial ends, in particular at the outlet of the notch. They can be electrically connected in parallel.

All the strands of all the electrical conductors having a free end located at the same circumferential position about the axis of rotation of the machine, regardless of their radial position, can be electrically connected to one another.

In another embodiment, each electrical conductor comprises three strands.

In the case where a notch comprises two electrical conductors, a notch can therefore house six strands, for example, distributed between the two electrical conductors.

In a variant, a notch comprises four electrical conductors. Each electrical conductor can comprise two strands. The notch then houses eight strands, distributed between the four electrical conductors.

The strands can be positioned in the notch so that their circumferential dimension around the axis of rotation of the machine is greater than their radial dimension. Such a configuration allows a reduction in eddy current losses in the strands.

A strand may have a width of between 1 and 5 mmm, for example of the order of 2.5 or 3 mm. The width of a strand is defined as its dimension in the circumferential direction about the axis of rotation of the machine.

A strand may have a height of between 1 and 4 mmm, for example of the order of 1.6 or 1.8 mm. The height of a strand is defined as its thickness in the radial dimension.

A ratio of the width of a strand to its height can be between 1 and 2.5, better still between 1.2 and 2, or even more preferably between 1.4 and 1.8, being for example 1.56 or 1.66. Such a ratio allows a reduction in eddy current losses in the strands.

The electrical conductors can be made of copper or aluminum.

Insulators

The electrical conductors are electrically insulated from the outside by an insulating coating, in particular an enamel. The electrical conductors can be separated from the walls of the notch by an insulator, in particular by at least one insulating sheet. Such a sheet insulator allows better insulation of the electrical conductors with respect to the stator mass. Using closed notches can make it possible to improve the retention of the insulators around the electrical conductors in the notches.

### Notches

The notches can be open or at least partially closed. A partially closed notch makes it possible to provide an opening at the air gap, which can be used, for example, to install the electrical conductors for filling the notch. A partially closed notch is in particular formed between two teeth that each comprise pole shoes at their free end, which close the notch at least in part.

In a variant, the notches can be completely closed. The term “fully closed notch” denotes notches which are not open radially toward the air gap.

The presence of the closed notches makes it possible to improve the performance of the electrical machine in terms of the quality of the magnetic field in the air gap, by minimizing the harmonic content and the eddy current losses in the electrical conductors, and the leakage fluxes in the notches, as well as the fluctuations of the magnetic field in the air gap and heating of the machine. In addition, the presence of these closed notches makes it possible to improve the mechanical rigidity of the stator, by mechanically strengthening the stator and by reducing vibrations.

The stator mass can be produced by stacking magnetic sheets, the notches being formed by cutting the sheets. The stator mass can also be produced by cutting from a mass of sintered or agglomerated magnetic powder.

### Machine and Rotor

A rotating electrical machine, such as a synchronous motor or a synchronous generator, is disclosed, the machine comprising a stator as defined above. The stator may comprise a stator mass comprising notches provided between teeth, each notch receiving one or more electrical conductors. The machine can be synchronous or asynchronous. The machine can be a reluctance machine. It can constitute a synchronous motor. The maximum speed of rotation of the machine can be high, being for example greater than 10,000 rpm, better still greater than 12,000 rpm, being for example of the order of 14,000 rpm to 15,000 rpm, or even 20,000 rpm or 25,000 rpm. The maximum speed of rotation of the machine may be less than 100,000 rpm, or even 60,000 rpm, or even less than 40,000 rpm, better still less than 30,000 rpm.

The rotating electrical machine may comprise a rotor. The rotor can be a permanent magnet rotor, with surface or buried magnets. The rotor can be in flux concentration. It can comprise one or more layers of magnets arranged in an I, a U or a V. In a variant, it may be a wound or squirrel cage rotor, or a variable reluctance rotor.

The diameter of the rotor may be less than 400 mm, better still less than 300 mm, and greater than 50 mm, better still greater than 70 mm, for example between 100 and 200 mm.

The rotor may comprise a rotor mass extending along the axis of rotation and arranged around a shaft. The shaft may comprise torque transmission means for driving the rotor mass in rotation.

The rotor may or may not be cantilevered.

The machine can be inserted alone in a housing or inserted in a gearbox housing. In this case, it is inserted in a housing which also houses a gearbox. Thus, the cooling device does not rest on the teeth of the stator mass. The distance d is small enough to allow thermal contact between the cooling device and the electrical conductors of the stator. For example, the distance d is less than 60 mm, better still less than 40 mm, for example, the distance d can be approximately 27 mm or 38 mm.

### Welding Method

Lastly, a method is disclosed for welding electrical conductors of an electrical machine stator, the method comprising at least the following steps:
installing a cooling device on the stator, in order to establish thermal contact between the cooling circuit of the cooling device and the electrical conductors of the stator,
circulating a coolant through the cooling device,
causing melting of the electrical conductors to weld them together.

Steps (b) of circulating a fluid and (c) of melting can be totally simultaneous. As a variant, the steps (b) of circulating a fluid and (c) of melting can be partially simultaneous. For example, step (b) of circulating a fluid can be initiated before step (c) of melting. Alternatively, step (b) of circulating a fluid can be initiated after step (c) of melting and continue afterwards.

The melting step (c) can be carried out by means of a heat source, in particular a laser or an electric arc.

The welding method using a tungsten electrode can be TIG (“Tungsten Inert Gas”) welding. In this welding method, the electric arc is produced from a tungsten electrode and a plasma. Using a heat source makes it possible to melt the free ends of the strands without degrading the assembly of the strands of the electrical conductor(s). A single heat source can be used to produce the same weld. Alternatively, several heat sources can be used to produce the same weld.

### BRIEF DESCRIPTION OF THE DRAWINGS

The invention may be better understood on reading the detailed description which follows, of non-limiting embodiments thereof, and on examining the appended drawing, in which:

FIG. 1 is a schematic and partial perspective view of a stator,

FIG. 2 is a schematic and partial perspective view of the stator of FIG. 1,

FIG. 3 is a detail perspective view of the stator of FIG. 1,

FIG. 4 is a diagram of the free ends of two electrical conductors to be welded in thermal contact with an example of a cooling device,

FIG. 5 is a top view of an example of a cooling device arranged facing a rotating electrical machine stator,

FIG. 6a is a top view of an example of a cooling device arranged facing a rotating electrical machine stator,

FIG. 6b is a top view of an example of a cooling device arranged facing a rotating electrical machine stator,

FIG. 7a is a detail view of the cooling device of FIG. 6a,

FIG. 7b is a detail view of an alternative embodiment of the cooling device,

FIG. 8a is a detail view of electrical conductors arranged in the same notch of a stator, in thermal contact with the cooling device of FIG. 6a,

FIG. 8b is a detail view of electrical conductors arranged in the same notch of a stator, in thermal contact with the cooling device of FIG. 6b,

FIG. 9 is a top view of an example of a cooling device arranged facing a rotating electrical machine stator,

FIG. 10 is a detail view of electrical conductors arranged in the same notch of a stator, in thermal contact with the cooling device of FIG. 9.

### DETAILED DESCRIPTION

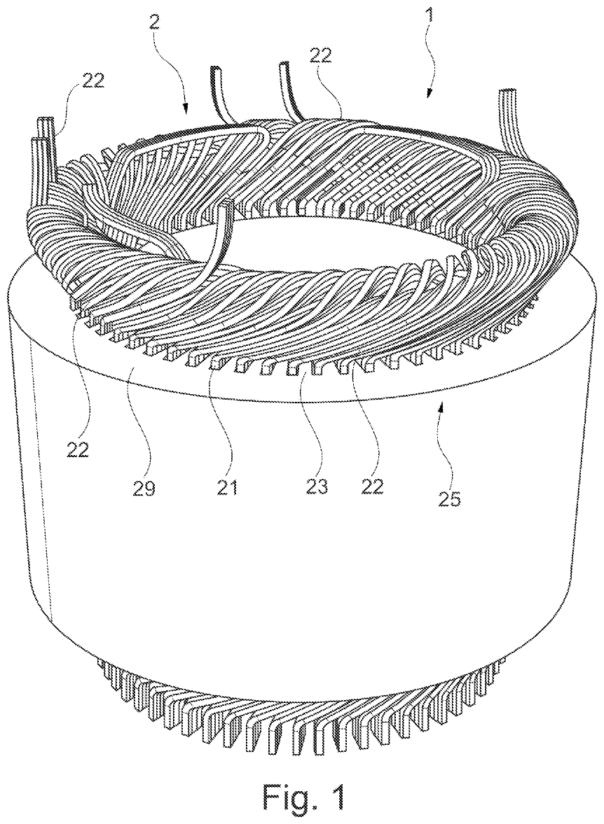

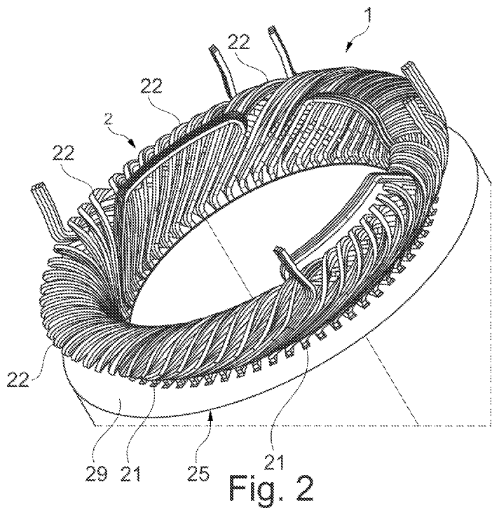

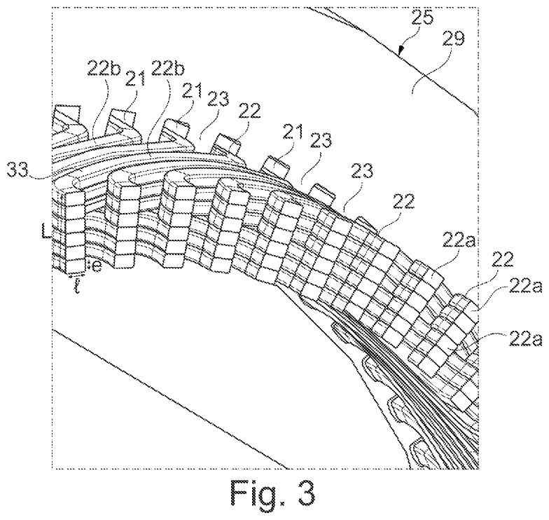

FIGS. 1 to 3 show a stator 2 of a rotating electrical machine 1 which also comprises a rotor, not shown. The stator makes it possible to generate a rotating magnetic field for driving the rotating rotor, in the context of a synchronous motor, and in the case of an alternator, the rotation of the rotor induces an electromotive force in the electrical conductors of the stator.

The examples illustrated below are schematic and the relative dimensions of the various component elements have not necessarily been observed.

The stator 2 comprises electrical conductors 22, which are arranged in notches 21 formed between teeth 23 of a stator mass 25. The notches 21 are closed.

The electrical conductors 22 comprise strands 33. The strands 33 have a generally rectangular cross-section, in particular with rounded corners. In the described example, the strands 33 are superimposed radially in a single row.

The thickness e of a strand 33 is its dimension in the radial direction of the machine. The width I of a strand 33 is defined as its dimension in the circumferential direction about the axis of rotation of the machine. The width L of the section to be welded corresponds to the sum of the thicknesses e of each strand.

The electrical conductors 22 are for the most part in the form of pins, namely U or I pins, and which extend axially in the notches. A first electrical conductor housed in a first notch is electrically connected to a second electrical conductor housed in a second notch, at the outlet from said notches.

The first and second notches are non-consecutive. In the illustrated example, they are separated by 7 other notches. Alternatively, the first and second notches are separated by 3, 4, 5, 6, 8, 9, 10 or 11 other notches, for example.

The electrical connection is formed on the electrical conductors just after they exit the two notches, at one axial end of the stator mass. The two electrical conductors each comprise an oblique portion 22b, which converge toward one another.

The electrical connection between two conductors is done in a plane perpendicular to the axis of rotation of the machine, causing the free ends 22a of the strands of the two electrical conductors to melt.

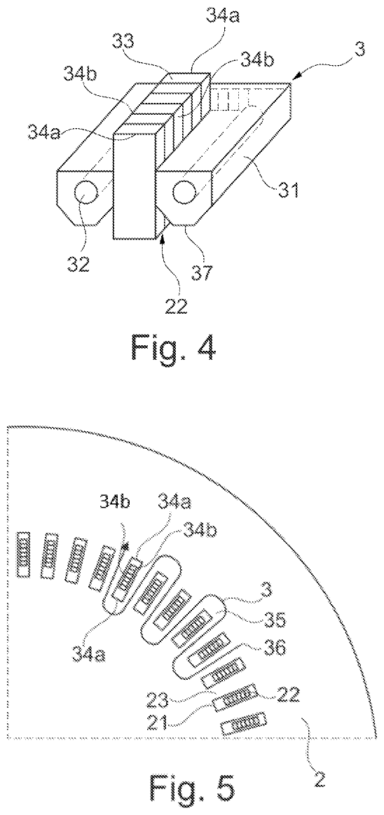

FIG. 4 illustrates the free ends of two electrical conductors 22 to be welded in thermal contact with a cooling device 3.

The cooling device 3 comprises a cooling circuit 31. A coolant 32, for example a mixture of water and glycol, circulates in the cooling circuit. The lower face 37 of the device has a beveled shape that facilitates the insertion of the electrical conductors 22 into the device 3.

FIG. 5 shows an example of a cooling device 3 arranged above a stator 2 of a rotating electrical machine. In this example, the conduit meanders between the free ends of the electrical conductors 22 to be welded. The cooling circuit of the device 3 slopes evenly between the electrical conductors 22. Each corrugation surrounds electrical conductors 22 arranged in the same notch 21 of the stator 2. The cooling circuit thus provides (defines) receiving spaces 35 for the free ends of the electrical conductors 22 to be welded. The receiving spaces 35 are for example superimposed on the notches 21 of the stator 2.

In the embodiment shown in FIGS. 4 and 5, all of the circumferential sides 34a and only one radial side 34b of each of the electrical conductors 22 are in thermal contact with the cooling device. In this embodiment, the cooling circuit 31 has a single inlet point 36 for the coolant. The coolant 32 circulates radially from the inside toward the outside above a first tooth 23 of the stator 2, then radially from the outside toward the inside above a second tooth 23, adjacent to the first.

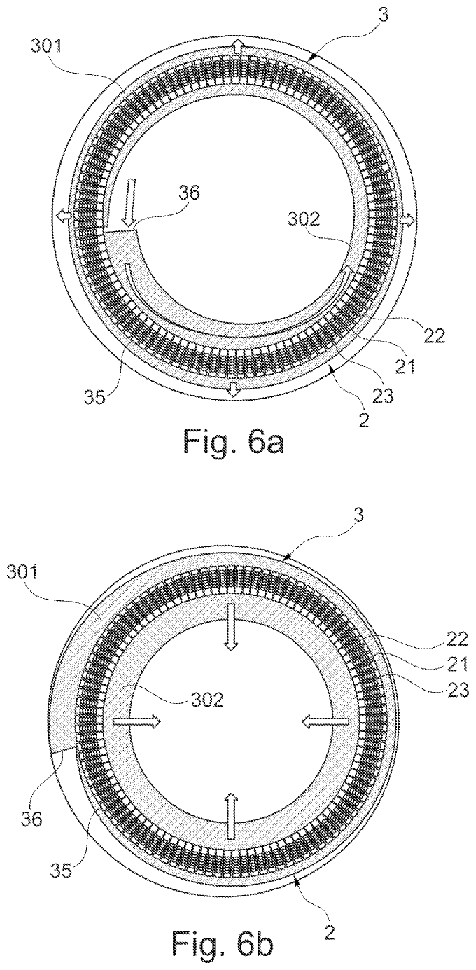

FIGS. 6a and 6b illustrate a cooling device 3 according to one embodiment arranged facing a stator 2 of a rotating electrical machine.

The cooling device 3 shown in FIGS. 6a and 6b comprises two concentric portions 301, 302 arranged radially on either side of the electrical conductors 22 of the stator 2. The two portions 301, 302 communicate via radial channels arranged between the electrical conductors, for example above all the teeth 23 of the stator 2.

The cooling circuit provides receiving spaces 35 for the free ends of the electrical conductors 22 to be welded. The receiving spaces 35 are for example superimposed on the notches 21 of the stator 2.

A first cooling circuit portion 302 is arranged inside the stator 2, in the space defined by the electrical conductors 22. A second cooling circuit portion 301 is arranged outside the stator 2, outside the space defined by the electrical conductors 22.

In the example shown in FIG. 6a, the inlet point 36 of the coolant is connected to the cooling circuit portion 302 arranged inside the stator. The coolant then flows from the inside to the outside of the stator.

In the example shown in FIG. 6b, the inlet point 36 of the coolant is connected to the cooling circuit portion 301 arranged outside the stator. The coolant then flows from the outside to the inside of the stator.

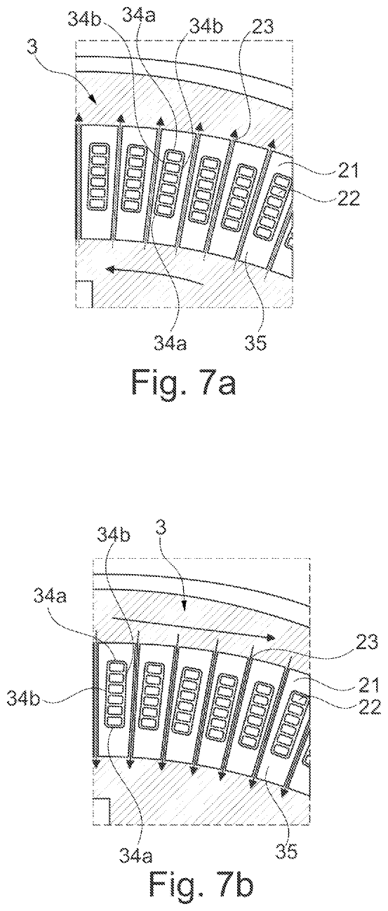

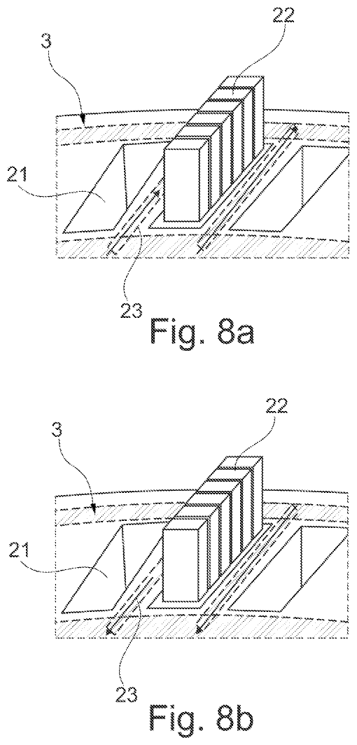

In the embodiment shown in FIGS. 6a, 7a and 8a and that shown in FIGS. 6b, 7b and 8b, all the radial sides 34b and all the circumferential sides 34a of each of the electrical conductors 22 of the stator 2 are in thermal contact with the device 3.

In the embodiments illustrated in FIGS. 5 to 8a, the receiving spaces 35 are of substantially rectangular shape.

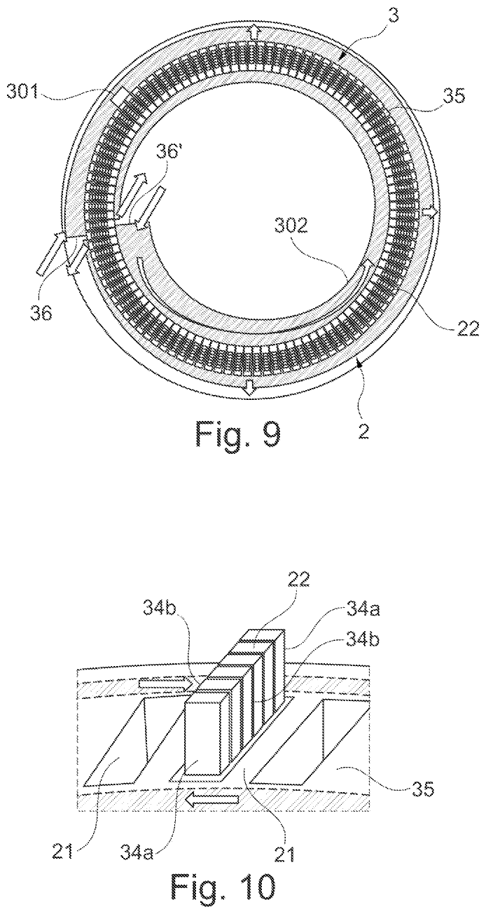

FIG. 9 illustrates another embodiment of the cooling device 3 arranged facing a stator 2 of a rotating electrical machine.

The cooling device 3 shown comprises two concentric portions 301, 302 arranged radially on either side of the electrical conductors 22 of the stator 2. The two portions 301, 302 do not communicate with one another. The cooling circuit therefore does not pass between the electrical conductors 22, above the teeth 21 of the stator 3.

The cooling circuit provides a single receiving space 35 for the free ends of the electrical conductors 22 to be welded.

A first cooling circuit portion 302 is arranged inside the stator 2, in the space defined by the electrical conductors 22. A second cooling circuit portion 301 is arranged outside the stator 2, outside the space defined by the electrical conductors 22.

The cooling circuit portion 301 has an inlet point 36 for the coolant. And the cooling circuit portion 302 comprises an inlet point 36′ for the coolant.

The two concentric portions 301, 302 of the cooling circuit can be passed through by counter-rotating coolants. In the embodiment shown, the outer portion 301 is passed through by a coolant circulating in the counterclockwise direction and the inner portion 302 is passed through by a coolant circulating in the counterclockwise direction.

In the example shown in FIGS. 9 and 10, all of the radial sides 34b of each of the electrical conductors 22 of the stator 2 are in thermal contact with the cooling device 3. None of the circumferential sides 34a of each of the electrical conductors 22 are in thermal contact with the cooling device 3.

In the embodiments of FIGS. 9 and 10, the cooling device comprises a single receiving space 35, which has the shape of a ring. This receiving space is arranged between the two concentric portions 301, 302 of the cooling circuit. The receiving space 35 extends over the entire circumference of the device. When the device is placed opposite the stator, the free ends of all the electrical conductors 22 are all inserted into the receiving space 35.

Of course, the invention is not limited to the embodiments that have just been described, and the rotor associated with the described stator can be wound, with a squirrel cage or with permanent magnets, or else with variable reluctance.

1. A device for cooling one or more electrical conductors of a stator of a rotating electrical machine, the device comprising at least one cooling circuit for a coolant, the device being adapted to be placed in thermal contact with at least a part of the electrical conductor(s) during a step of welding said electrical conductors.

2. The device according to claim 1, the device being of substantially flattened shape, comprising an upper face and a lower face, the lower face being intended to be opposite the stator during the welding step.

3. The device according to claim 1, the cooling circuit defining receiving spaces sized to receive the free ends of the electrical conductors to be welded.

4. The device according to claim 2, the underside of the device defining a beveled shape at the receiving spaces for the free ends of the electrical conductors to be welded.

5. The device according to claim 1, the cooling circuit being configured to be traversed by a coolant circulating circumferentially and/or radially with respect to the axis of rotation of the rotating electrical machine.

6. The device according to claim 1, at least one of the radial sides and/or one of the circumferential sides of the electrical conductors arranged in the same notch of the stator being in thermal contact with the cooling circuit.

7. The device according to claim 1, the cooling circuit comprising a conduit for the circulation of the coolant, the conduit winding between the free ends of the electrical conductors to be welded.

8. The device according to claim 1, the cooling circuit comprising two concentric portions arranged radially on either side of the electrical conductors of the stator, the two portions communicating via radial channels arranged between the electrical conductors, above all or a portion of the teeth of the stator.

9. The device according to claim 1, the cooling circuit comprising two concentric portions that do not communicate with each other and being arranged radially on either side of the electrical conductors of the stator, the coolant circulating in each of said portions in opposite directions.

10. The device according to claim 9, the device being at least partially manufactured by additive manufacturing.

11. An assembly comprising the cooling device according to claim 1 and a stator of a rotating electrical machine, the stator comprising a stator mass comprising notches provided between teeth, each notch receiving one or more electrical conductors.

12. The assembly according to claim 11, the stator comprising at least some electrical conductors, if not a majority of the electrical conductors, in the form of U or I pins.

13. The assembly according to claim 11, the device being maintained above the stator at a non-zero distance d during welding of the electrical conductors of the stator.

14. A method for welding electrical conductors of an electrical machine stator, comprising at least the following steps:
(a) installing the cooling device according to claim 1 on the stator in order to establish thermal contact between the cooling circuit of the cooling device and the electrical conductors of the stator,
(b) circulating a coolant through the cooling device, and
(c) causing melting of the electrical conductors to weld them together.

15. The method according to claim 14, the melting step (c) being carried out by means of a heat source, in particular a laser or an electric arc.
